(19) United States
(12) Patent Application Publication
(10) Pub. No.: US 2022/0316827 A1
(43) Pub. Date: Oct. 6, 2022

(54) SENSOR ASSEMBLY FOR HEAT EXCHANGER

(71) Applicant: Tranter, Inc., Wichita Falls, TX (US)

(72) Inventors: Robin G. Steininger-Juarez, Wichita Falls, TX (US); Shawoon Roy, Mymensingh (BD); Jason L. Williams, Wichita Falls, TX (US)

(21) Appl. No.: 17/637,391

(22) PCT Filed: Aug. 21, 2020
(86) PCT No.: PCT/US2020/047297

§ 371 Date: Feb. 22, 2022

Related U.S. Application Data
(60) Provisional application No. 62/890,895, filed on Aug. 23, 2019.

(51) Int. Cl. F28F 27/00; F28F 9/02; F28D 9/00

(52) U.S. Cl. CPC F28F 27/00; F28F 9/0219; F28D 9/005; F28F 2265/12; F28F 2265/10

(57) ABSTRACT

In at least some implementations, a plate for a heat exchanger defines at least in part a flow channel for a working fluid of the heat exchanger, the plate defines an aperture adjacent the flow channel, and the aperture has a sensor assembly disposed therein. The sensor assembly includes a body mounted to the aperture and at least in one of a temperature sensor and a pressure sensor secured within the body, and the body forming in part the flow channel for the working fluid.

### REFERENCE TO RELATED APPLICATIONS

This application claims the benefit of U.S. Provisional Application Ser. No. 62/890,895 filed on Aug. 23, 2019 the entire contents of which are incorporated herein by reference in its entirety.

### TECHNICAL FIELD

This disclosure relates to a plate, a core and/or a heat exchanger including a sensor assembly

### BACKGROUND

At least some conventional heat exchangers may be classified into two categories, tubular heat exchangers and plate heat exchangers. Plate heat exchangers are manufactured by stacking a plurality of plates, configured in a way so that two fluids, one relatively hot and the other relatively cold, may be passed between alternating channels defined by the plates. The stacked plates are received within a shell having suitable inlet and outlet ports for the two fluids. Seals are provided and the internal cavity defined by a housing and the plates is enclosed and not accessible from the exterior of the housing in use of the heat exchanger.

### SUMMARY

In at least some implementations, a plate for a heat exchanger defines at least in part a flow channel for a working fluid of the heat exchanger, the plate defines an aperture adjacent the flow channel, and the aperture has a sensor assembly disposed therein. The sensor assembly includes a body mounted to the aperture and at least one of a temperature sensor and a pressure sensor secured within the body, and the body forming in part the flow channel for the working fluid.

In at least some implementations, the sensor assembly includes a strain gauge. And the strain gauge may be mounted to a wall of the body, the wall forming in part the flow channel for the working fluid. In at least some implementations, the sensor assembly includes a resistance temperature detector (RTD) or thermocouple.

In at least some implementations, the plate includes a seal extending about a perimeter of the body, the seal is positioned between the body and the plate and is configured to prevent the working fluid from intrusion between the body and the plate and into the aperture.

In at least some implementations, a wall of the body is impervious to liquid and defines part of the flow channel. The wall may include a thinner portion that defines part of the flow channel and which flexes in response to the pressure of fluid within the flow channel.

In at least some implementations, the body includes a flange, and the body is secured to the plate within the aperture by a nut with the plate trapped between the flange and the nut. The body may include a sidewall received through the aperture and including threads on which the nut is received.

In at least some implementations, the body includes an end face that defines part of the flow channel and a cavity on an opposite side of the end face as the flow channel, and wherein at least one of a pressure sensor and temperature sensor are received in the cavity. In at least some implementations, the body includes an end face that defines part of the flow channel and wherein the end face is flush or within 5 mm of flush with an adjacent side of the plate that defines part of the flow channel.

In at least some implementations, a networked heat exchanger includes a plurality of plates, including an end plate positioned at an end of the plurality of plates, each plate defining flow channels configured to circulate a first fluid and a second fluid in alternating fashion between the plates, wherein the end plate defines an aperture having a sensor assembly disposed therein, the aperture positioned adjacent a flow channel defined in part by the end plate, wherein the sensor assembly includes a body mounted to the plate at least partially in the aperture and at least one of a temperature sensor and a pressure sensor secured within the body, the body forming in part the flow channel for the working fluid, and an electronics module in communication with the at least one of the temperature sensor and the pressure sensor, the electronics module configured to communicate with one of an external gateway and a communications network.

In at least some implementations, the heat exchanger also includes a housing surrounding the plurality of plates, and wherein the end plate is received between one of the plurality of plates and the housing with one of the first fluid or the second fluid in contact with an internal side of the end plate and with no fluid in contact with an external side of the end plate, and wherein the sensor assembly is exposed to the external side of the end plate and sealed from the internal side of the end plate.

In at least some implementations, the body is received in the aperture and is sealed to the end plate with an end face of the body defining part of the flow channel along with the internal side of the end plate, and wherein the body has a cavity in which said at least one of a temperature sensor and a pressure sensor is received. The end face may be impervious to fluid flow therethrough.

In at least some implementations, a core for a gasketed plate heat exchanger includes a plurality of plates, including an end plate positioned at an end of the plurality of plates, each plate defining flow channels configured to circulate a first fluid and a second fluid in alternating fashion between the plates. The end plate defines an aperture having a sensor assembly disposed therein, the aperture is positioned adjacent a flow channel defined in part by the end plate. The sensor assembly includes a body mounted to the aperture and at least one of a temperature sensor and a pressure sensor secured within the body, the body forming in part the flow channel for the working fluid.

In at least some implementations, the body is received in the aperture and is sealed to the end plate with an end face of the body defining part of the flow channel along with the internal side of the end plate, and wherein the body has a cavity on an opposite side of the end face as the flow channel, with said at least one of a temperature sensor and a pressure sensor received in the cavity. In at least some implementations, the end face is impervious to fluid flow therethrough.

### BRIEF DESCRIPTION OF THE DRAWINGS

The following detailed description of certain embodiments and best mode will be set forth with reference to the accompanying drawings, in which:

FIG. 1 is a front view of an example plate-type heat exchanger;

FIG. 2 is a side view of the heat exchanger of FIG. 1;

FIG. 3 is a front view of one implementation of a heat transfer plate for the plate-type heat exchanger of FIG. 1;

FIG. 4 is a perspective view of one implementation of an end plate for the plate-type heat exchanger of FIG. 1;

FIG. 5 is an exploded perspective view of a sensor assembly for a heat transfer plate such as the end plate of FIG. 4; and

FIG. 6 is an exploded sectional view of the sensor assembly of FIGS. 4 and 5.

### DETAILED DESCRIPTION

Example illustrations are provided of a heat exchanger that facilitates remote monitoring of one or more operational conditions via one or more sensors installed within the heat exchanger. For example, a plurality of plates may define flow passages for working fluid(s) of the heat exchanger. One of the plates may be an end plate that defines at least in part one of the flow channels. The plate may define an aperture adjacent the flow channel, and may have a sensor assembly disposed in the aperture. The sensor assembly includes a body mounted to the aperture and at least one of a temperature sensor and a pressure sensor secured within the body. The body forms, in part, the flow channel for the working fluid. Accordingly, one or more sensors disposed in the sensor assembly may measure or determine operating parameters associated with a working fluid of the heat exchanger.

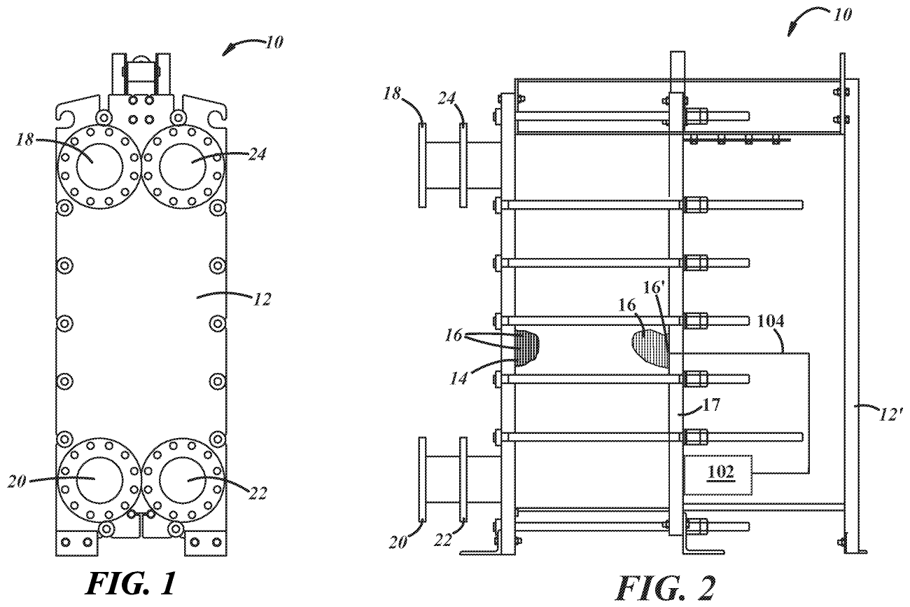

Referring in more detail to the drawings, FIGS. 1 and 2 illustrate one example of a heat exchanger 10 including an outer housing 12 and an inner core 14 (FIG. 2—shown via a partial broken section of the housing) or plate pack that includes multiple heat exchanger plates 16. The heat exchanger 10 is shown as a plate heat exchanger having a basically rectangular core 14, although other shapes and configurations are possible. The housing 12 may include a first inlet 18, a first outlet 20, a second inlet 22 and a second outlet 24. A first fluid may be received into and exit from the housing 12 via the first inlet 18 and first outlet 20. A second fluid may be received into and exit from the housing 12 via the second inlet 22 and second outlet 24. The fluids may be in heat transfer communication with each other through the intervening or interposed plates 16 of the core 14, in any manner that is convenient. For example, the inlets 18, 22 and outlets 20, 24 may be defined by conduits that may be welded to one or more walls of the housing 12, and the walls may be clamped or welded together to define an at least substantially complete enclosure.

The inner core 14 or plate pack may include multiple heat transfer plates 16 that may be generally flat and rectangular, although other shapes may be used. The plates 16 may be clamped together, e.g., by way of a movable wall 17 that partially defines the housing 12. The internal arrangement and construction of the core 14, including the plate pack, can be substantially as disclosed in U.S. Pat. No. 6,516,874, the disclosure of which is incorporated herein by reference in its entirety. In general, a plurality of cassettes may be located within the housing with each cassette constructed from two heat transfer plates 16 sealed together (e.g., by a weld or gasket(s)). In forming a cassette, one of the heat transfer plates 16 may be rotated 180 degrees and/or turned over so that one of the plates is superimposed upon the other. This causes the corrugations of each of the heat transfer plates 16 to cross each other at a fixed angle, and also defines flow passages between the plates through which fluid flows. The plate pack 14 consists of multiple cassettes stacked together and may be arranged so that the fluid flows in the spaces between each pair of adjacent plates. In at least some implementations, the first fluid flows through the space between every other plate 16 and the second fluid flows through the spaces between the other plates. For example, with plates A, B, C, D and E sandwiched together in a plate pack, the first fluid would flow between plates A and B, and plates C and D. The second fluid, in this example, would flow between plates B and C, and plates D and E. Thus, fluid flows on both of the opposed sides (which may be called front and rear) of at least the internal plates (in the simple example, plates B, C and D) of the plate pack, and in the example described, a different fluid flows on the opposed front and rear sides of these plates to improve heat transfer between the fluids and plates.

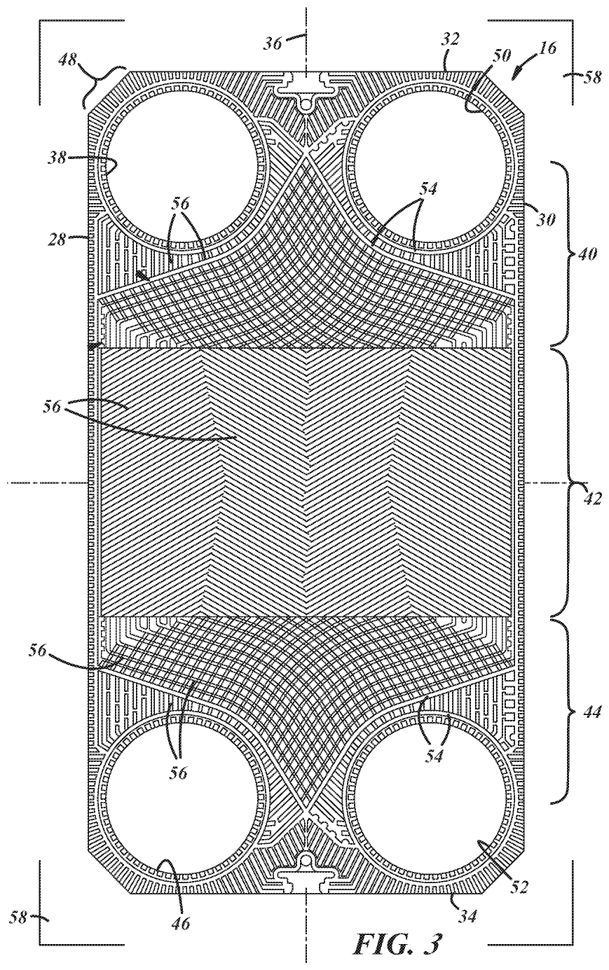

Turning now to FIG. 3, each plate 16 of the heat exchanger 10 may be a thin, generally rectangular sheet of metal, such as stainless steel or titanium. The plate 16 may include parallel first and second side edges 28, 30 on opposed sides of the plate, and parallel first and second end edges 32, 34 at opposed ends of the plate. The side edges 28, 30 define a length of the plate 16 and extend longitudinally or parallel to a longitudinal centerline 36 of the plate 16 and the end edges 32, 34 define a width of the plate 16 and extend laterally, perpendicular to the longitudinal centerline 36. From a first end 32 of the plate 16 toward a second end 34, the plate may include a first opening 38 that serves as an inlet port that is communicated with the first inlet 18 for the first fluid which may be a heat transfer fluid (e.g. water), a diverging fluid distribution zone 40, a middle or heat transfer zone 42, a converging fluid collection zone 44 and a second opening 46 that serves as an outlet port for the heat transfer fluid that is communicated with the first outlet 20. The inlet opening 38 may be located adjacent to but spaced from both the first end edge 32 and the first side edge 28 such that the inlet opening is located near a corner or juncture 48 of the first end edge 32 and first side edge 28 and is enclosed by the plate 16 (i.e. the opening 38 does not extend through an edge of the plate). In this way, appropriate seals (e.g., weld/gasket) can be utilized to prevent leakage of the heat transfer fluid from the plate pack 14. The plate 16 may also include a third opening 50 adjacent to the first end and second side edges 32, 30, respectively, and a fourth opening 52 adjacent to the second end and second side edges 34, 30 respectively. The third and fourth openings 50, 52 may be mirrored about the centerline 36 relative to the first and second openings 38, 46, respectively. The third and fourth openings 50, 52 may be provided to facilitate use of the same plate design in different orientations to provide the flow paths described herein (e.g. to communicate with the second inlet 22 and second outlet 24 for the second fluid, sometimes called the working fluid the temperature of which is changed by the heat exchanger). As shown in FIG. 3, in at least some implementations, channels 54 for a seal or gasket circumscribe the third and fourth openings 50, 52 to provide a circumferentially continuous seal around these openings designed to prevent fluid flow into those openings.

As noted above, the fluids flow in spaces defined between adjacent plates 16, where the spaces are defined by non-planar features, called corrugations 56 herein, formed in the plates. The corrugations 56 may be formed as drawn or pressed-in channels that are concave when viewed from the front side of the plate 16 and convex when viewed from the rear side, or vice versa. The perimeter/edges 28-32 of the plate 16 may be left flat or planar to facilitate sealing together adjacent plates at the perimeter via welds and/or gaskets as noted above. A reference plane 58 may be defined that is parallel to the centerline 36 and may include the perimeter of the plate 16, as shown in FIG. 3, and the corrugations 56 may extend away from the plane 58 in one or both directions, as desired.

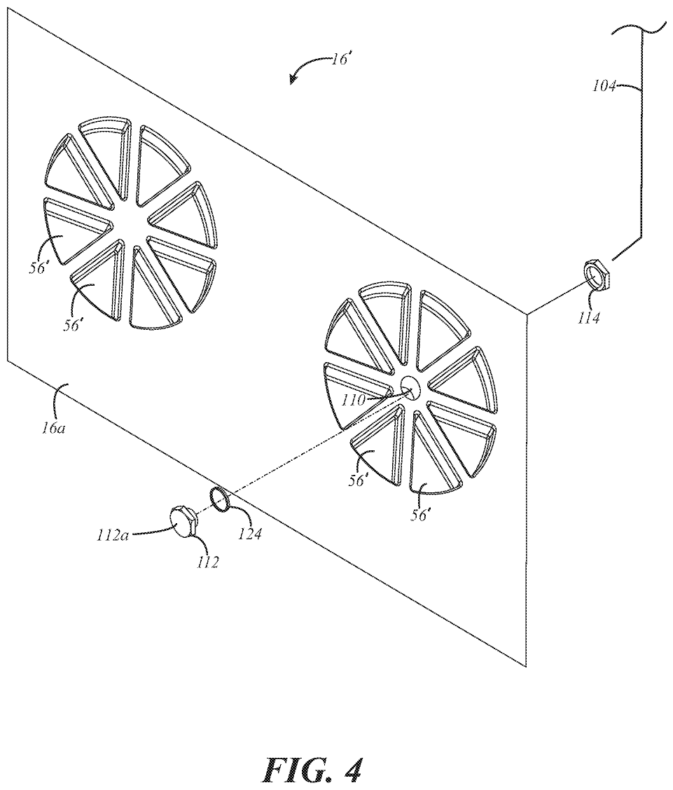

As best seen in FIGS. 2 and 4, the plate pack 14 may have an end plate 16′ that is positioned at an end of the stack of plates 16. The end plate 16′ may be provided with a sensor assembly 100, which is best seen in FIGS. 4, 5, and 6. The sensor assembly 100 may generally provide for monitoring of various operational conditions, parameters and/or measurements associated with operation of the plate pack 14 and/or heat exchanger 10, as will be described further below. The sensor assembly 100 may be in communication with an electronics box 102, e.g., by way of wiring 104, as shown in FIG. 2. While the electronics box 102 is illustrated as being attached to/adjacent the heat exchanger 10, in some examples the electronics box 102 may be remote from the heat exchanger 10, and may communicate wirelessly with the heat exchanger 10 or components thereof, e.g., the sensor assembly 100. The electronics box 102 may generally communicate with a local network or other communication mechanism associated with an installation facility or location of the heat exchanger 10. Alternatively, the sensor assembly 100 may be configured to allow for wireless communication, for example by way of one or more wireless transmitters and/or antennas (not shown). In either case, the electronics box 102 generally facilitates monitoring of the heat exchanger 10 by maintenance personnel, and thus performance of the heat exchanger 10 may be monitored remotely. Merely by way of example, as will be discussed further below temperature and/or pressure within the heat exchanger 10, such as in working fluid(s) of the heat exchanger 10, may be monitored. Additionally, pressure drop across working fluid(s) of the heat exchanger 10 may also be monitored.

The electronics box 102 may transmit data regarding parameters sensed by the sensor assembly 100 to a central office, customer facility, computer, tablet or other handheld device, or the like to allow remote or easier and more convenient on-site analysis of the performance or internal conditions of the heat exchanger 10. The electronics box 102 may be powered using AC power, via a battery (not shown), or in any other manner that is convenient. In one example, the electronics box 102 may be configured to transmit performance data wirelessly to a local network, e.g., via a Bluetooth or WiFi connection. Accordingly, the electronics box may send performance data to a remote monitoring facility via a gateway or local network associated with the facility where the heat exchanger 10 is installed. In another example, the electronics box 102 may be configured to communicate directly “to the cloud,” e.g., using a cellular network or the like. Regardless of the manner of implementation, performance data associated with the heat exchanger 16 may be made available remotely, which may be accessed by off-site service personnel associated with the heat exchanger 10.

In some examples, temperature and pressure sensors may be provided by way of the sensor assembly 100, and may facilitate monitoring changes in temperatures and pressures over time in the heat exchanger 10. The collected temperature and pressure data may be used to predict when maintenance or replacement of components of the heat exchanger 10 may be beneficial. For example, temperature and pressure data may be used to determine when maintenance is needed, e.g., by providing an indication of a decrease in performance of the heat exchanger 10, which may be due, for example, to fouling or contamination within the heat exchanger. More specifically, maintenance may be scheduled based upon predicted flow rates determined from pressure drops measured by the sensor assembly 100, and/or from predicted temperature differences for the heat exchanger 10. Performance of the heat exchanger 10 over time may be observed by temperature/pressure data, and may thus be used to determine optimum intervals and/or times for maintenance.

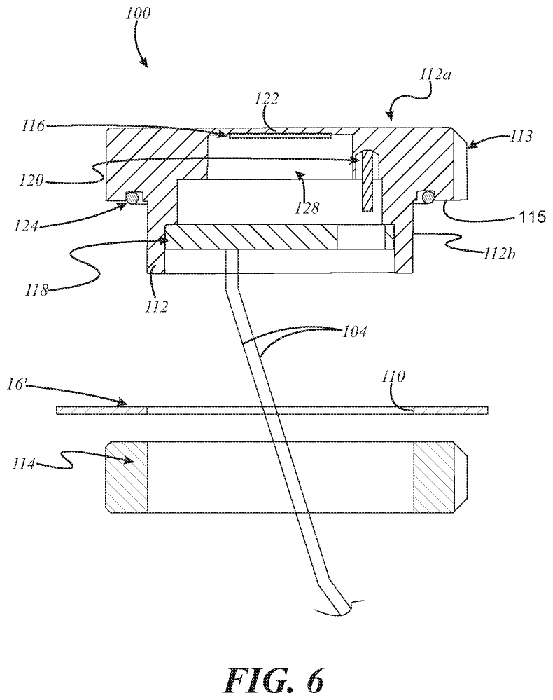

Turning now to FIGS. 4-6, the sensor assembly 100 and installation to the end plate 16′ is described in further detail. The end plate 16′ may include corrugations 56′ providing a fluid flow path for the first and/or second fluids, in cooperation with an adjacent plate 16 in the plate pack (not shown in FIG. 4). That is, an internal side 16a of the end plate 16′ generally forms part of the enclosure and flow path for one of the working fluid(s) of the heat exchanger 10. Fluid does not flow and is not present on the opposite side of the plate, which is adjacent to a wall of the housing 12. This provides an open and dry space in which one or more wires 104 (FIGS. 2 and 6) or other electrical components of the assembly may be received or open to, without being exposed to liquid.

The sensor assembly 100 may take the form of an instrumentation “puck” that is fixed to the end plate 16′ within an opening provided through the end plate. The sensor assembly 100 may be placed into contact with a working fluid of the heat exchanger 10, e.g., the first fluid or the second fluid, along with the internal face 16a of the end plate 16′. In the example illustrated in FIG. 4, an aperture 110 formed in the end plate 16′ generally receives the sensor assembly 100. A body portion 112 of the sensor assembly 112 may be retained on the end plate 16′ with a ring or nut 114. The body portion 112 may be relatively thin in the direction of a central axis of the body portion, particularly with respect to the internal face 16a of the end plate 16′, such that the sensor assembly 100 does not protrude significantly into the working fluid of the heat exchanger 10. In at least some implementations, an end face 112a of the body 112 may be flush or within 5 mm of flush with the adjacent portion of the internal side 16a of the end plate to provide a stepless transition between a wall (e.g. end face) 112a and immediately adjacent portion of the internal side 16a, or a minimal (1 mm or less) step between them. The working fluid and operation of the heat exchanger 10 may thus be relatively undisturbed by the presence of the sensor assembly 100. In at least some implementations, the end face 112a defines part of the flow channel for the working fluid and may be solid, that is, without an aperture or void and impervious to liquid such that liquid does not flow through the end face 112a. Thus, electronics or other components stored behind the end face 112a may be shielded from fluid by the end face 112a and any seals about the periphery of the body 112 or otherwise between the body and the plate 16′. The body 112 may include a head 113 that includes the end face 112b and that extends radially outwardly beyond an exteriorly threaded and generally cylindrical sidewall 112b to provide an annular flange 115 facing in the opposite direction as the end face 112b. In assembly, the sidewall 112b is received through the aperture 110 and includes threads for threaded coupling of the nut 114, with the end plate 16′ trapped between the flange 115 and the nut 114, as best shown in FIGS. 4 and 6. An o-ring 124, gasket or other seal may be provided to facilitate providing a fluid-tight seal that prevents the working fluid on the internal side 16a of the end plate 16′ from leaking through the aperture 110.

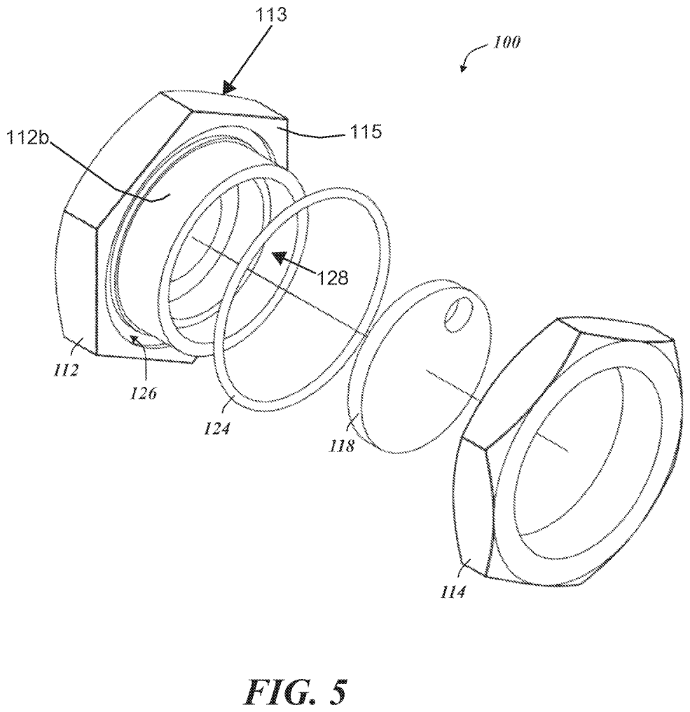

The sensor assembly 100 may be provided with any sensors or electronics that are convenient or desired for determining operating parameters of the heat exchanger 10. The sensor assembly 100 may be configured to determine a pressure associated with the heat exchanger 10, e.g., pressure of one or both of the first and second fluids circulated within the heat exchanger. For example, as best seen in FIG. 6, the body 112 may carry a pressure sensor (e.g. a strain gauge) 116 within a cavity 128 that is defined within the sidewall 112b and which is enclosed at one end by the end face 112a. The strain gauge 116 may be positioned on a back side of the end face 112a, such as on a thinner portion 122 of the end face 112 open to the cavity 128 and which is constructed to flex or otherwise be responsive to the pressure of the working fluid acting on that portion 122 of the end face 112a to permit determination of changes in the pressure of the working fluid. For example, the end face may flex in response to a pressure differential between (a) the first or second fluid adjacent the end face 112a and (b) the external environment on the opposite side of the end plate 16′. The pressure differential may also act upon the end plate 16′, with the strain gauge 116 acting generally as a load cell or pressure cell within the end plate 16′. The strain gauge 116 may therefore detect or measure strain of the body 112 and/or the end plate 16′. In one example, the strain gauge 116 is a circular diaphragm strain gauge 116. The strain gauge 116 may also be in communication with a processor and/or memory that is calibrated to determine pressure of the fluid(s) adjacent the sensor assembly 100, e.g., from strain measured by the strain gauge 116. In the example illustrated in FIGS. 5 and 6, a printed circuit board (PCB) 118 is provided, which includes a processor and a computer-readable memory, e.g., a non-transitory computer-readable memory, which include instructions that, when executed by the processor, are configured to determine pressure via the strain gauge 116.

The sensor assembly 100 may also measure temperature, e.g., of a fluid adjacent the end plate 16′ and acting on the end face 112a. As best seen in FIG. 6, a temperature sensor, which may be, by way of a non-limiting example, a resistance temperature detector (RTD) or thermocouple 120, may be received in the cavity 128 of the body 112. The RTD 120 may also be in communication with the PCB 118. Accordingly, the PCB 118 may generally receive signals from the RTD 120 relating to temperature, and from the strain gauge 116 relating to pressure.

The internal location of the sensor assembly 110, i.e., on the end plate 16′ with the body 112 in contact with working fluid(s) of the heat exchanger 10, generally facilitates retrofitting of the sensor assembly 100 to existing heat exchangers. More specifically, the sensor assembly 100 may be installed in an existing heat exchanger by replacing the existing end plate with the example end plate 16′. Previous approaches to monitoring heat exchanger performance require installation of sensors at fluid inlets or outlets of the unit, and limiting retrofitting opportunities due to the impact on plumbing external to the plate pack 14. External electronics, e.g., the electronics module or box 102, may also be mounted relatively easily on the heat exchanger 10, e.g., to a movable cover of the housing 12. The wires 104 for electronics and including power to the device, may pass through a wall (e.g. wall 12′ shown in FIG. 2) of the heat exchanger housing 12, and/or the movable wall 17 of the core 14, that leads to the dry chamber defined by the external side of the end plate 16′ and the housing 12. In this way, the wires 104 are not within liquid and need not be resistant to liquids, and the opening(s) through the housing (e.g. through a housing wall and/or a wall of structure defining part of the core 14) through which the wires 104 pass need not be sealed against liquid under pressure (recognizing that the openings may include a dust/debris shield or seal, as desired). Thus, either in a newly built heat exchanger or in a retrofitted unit, the sensor assembly and related wires may be conveniently and easily installed.

The forms of the invention herein disclosed constitute presently preferred embodiments and many other forms and embodiments are possible. It is not intended herein to mention all the possible equivalent forms or ramifications of the invention. It is understood that the terms used herein are merely descriptive, rather than limiting, and that various changes may be made without departing from the spirit or scope of the invention.

1. A plate for a heat exchanger that defines at least in part a flow channel for a working fluid of the heat exchanger, the plate defining an aperture adjacent the flow channel, the aperture having a sensor assembly disposed therein, wherein the sensor assembly includes a body mounted to the aperture and at least one of a temperature sensor and a pressure sensor secured within the body, the body forming in part the flow channel for the working fluid.

2. The plate of claim 1, wherein the sensor assembly includes a strain gauge.

3. The plate of claim 2, wherein the strain gauge is mounted to a wall of the body, the wall forming in part the flow channel for the working fluid.

4. The plate of claim 1, wherein the sensor assembly includes a resistance temperature detector (RTD) or thermocouple.

5. The plate of claim 1, further comprising a seal extending about a perimeter of the body, the seal positioned between the body and the plate and configured to prevent the working fluid from intrusion between the body and the plate and into the aperture.

6. The plate of claim 1 wherein a wall of the body is impervious to liquid and defines part of the flow channel.

7. The plate of claim 1 wherein the body includes a flange, and the body is secured to the plate within the aperture by a nut with the plate trapped between the flange and the nut.

8. The plate of claim 7 wherein the body includes a sidewall received through the aperture and including threads on which the nut is received.

9. The plate of claim 6 wherein the wall includes a thinner portion that defines part of the flow channel and which flexes in response to the pressure of fluid within the flow channel.

10. The plate of claim 1 wherein the body includes an end face that defines part of the flow channel and a cavity on an opposite side of the end face as the flow channel, and wherein at least one of a pressure sensor and temperature sensor are received in the cavity.

11. The plate of claim 1 wherein the body includes an end face that defines part of the flow channel and wherein the end face is flush or within 5 mm of flush with an adjacent side of the plate that defines part of the flow channel.

12. A networked heat exchanger, comprising:
a plurality of plates, including an end plate positioned at an end of the plurality of plates, each plate defining flow channels configured to circulate a first fluid and a second fluid in alternating fashion between the plates;
wherein the end plate defines an aperture having a sensor assembly disposed therein, the aperture positioned adjacent a flow channel defined in part by the end plate, wherein the sensor assembly includes a body mounted to the plate at least partially in the aperture and at least one of a temperature sensor and a pressure sensor secured within the body, the body forming in part the flow channel for the working fluid; and
an electronics module in communication with the at least one of the temperature sensor and the pressure sensor, the electronics module configured to communicate with one of an external gateway and a communications network.

13. The heat exchanger of claim 12 which also includes a housing surrounding the plurality of plates, and wherein the end plate is received between one of the plurality of plates and the housing with one of the first fluid or the second fluid in contact with an internal side of the end plate and with no fluid in contact with an external side of the end plate, and wherein the sensor assembly is exposed to the external side of the end plate and sealed from the internal side of the end plate.

14. The heat exchanger of claim 12 wherein the body is received in the aperture and sealed to the end plate with an end face of the body defining part of the flow channel along with the internal side of the end plate, and wherein the body has a cavity in which said at least one of a temperature sensor and a pressure sensor is received.

15. The heat exchanger of claim 14 wherein the end face is impervious to fluid flow therethrough.

16. A core for a gasketed plate heat exchanger, comprising:
a plurality of plates, including an end plate positioned at an end of the plurality of plates, each plate defining flow channels configured to circulate a first fluid and a second fluid in alternating fashion between the plates;
wherein the end plate defines an aperture having a sensor assembly disposed therein, the aperture positioned adjacent a flow channel defined in part by the end plate, wherein the sensor assembly includes a body mounted to the aperture and at least one of a temperature sensor and a pressure sensor secured within the body, the body forming in part the flow channel for the working fluid.

17. The heat exchanger of claim 16 wherein the body is received in the aperture and sealed to the end plate with an end face of the body defining part of the flow channel along with the internal side of the end plate, and wherein the body has a cavity on an opposite side of the end face as the flow channel, with said at least one of a temperature sensor and a pressure sensor received in the cavity.

18. The heat exchanger of claim 17 wherein the end face is impervious to fluid flow therethrough.
